(19) United States
(12) Patent Application Publication
(10) Pub. No.: US 2006/0152834 A1
(43) Pub. Date: Jul. 13, 2006

(54) Projection TV

(75) Inventors: Young-il Kah, Suwon-si (KR); Sung-gi Kim, Suwon-si (KR); Seok-il Yoon, Daejeon (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/262,811

(22) Filed: Nov. 1, 2005

(30) Foreign Application Priority Data
Jan. 7, 2005 (KR) 10-2005-0001812

(51) Int. Cl. G02B 5/08

(52) U.S. Cl. 359/883; 359/884

(57) ABSTRACT

A projection TV is provided comprising a reflective mirror including an ultra-thin glass substrate having enhanced strength, a reflective layer formed on a surface of the glass substrate to reflect an image, and a protective layer applied to an upper surface of the reflective layer to prevent the reflective layer from being damaged. The reflective mirror minimizes the occurrences of a double image, and a focus characteristic and contrast are enhanced, thereby improving the image quality. In addition, it is possible to make the product lightweight and thus, reduce transportation charges and other manufacturing costs.

### CROSS-REFERENCE TO RELATED APPLICATIONS

This application claims the benefit under 35 U.S.C. §119(a) of Korean Patent Application No. 10-2005-0001812 filed in the Korean Intellectual Property Office on Jan. 7, 2005, the entire disclosure of which is incorporated herein by reference.

### BACKGROUND OF THE INVENTION

1. Field of the Invention

The present invention relates to a projection TV. More particularly, the present invention relates to a projection TV that is capable of improving a resolution of an image and providing a lightweight product with reduced manufacturing costs, by using a thin glass having a heat-enhanced strength as a reflective mirror, and thus, drastically reducing a thickness of the reflective mirror.

2. Description of the Related Art

A conventional projection TV produces an image using an image forming means such as a cathode ray tube (CRT) or liquid crystal device (LCD) as a source of the image, and projects the image on a large scaled screen through a projection lens and a reflective mirror, thereby realizing a large scaled image.

The conventional reflective mirror used for the projection TV comprises a transparent glass substrate, a reflective layer made of silver or aluminum applied to a surface of the substrate and reflecting image light, and a protective layer formed with copper applied to a top surface of the reflective layer and preventing oxidation. The reflective mirror is classified into categories including a front projection type and a rear projection type, according to whether the reflective layer and the protective layer are formed on a front surface of the glass substrate, that is, a surface to which the image light is incident, or a rear surface of the glass substrate.

Since the front projection type reflects the image light on the surface of the reflective mirror, an image quality is clearer. However, since the image light directly reaches the reflective layer and the protective layer, uniformities of the reflective layer and the protective layer directly affect the image quality. In addition, a manufacturing cost is increased because a method requiring advanced technologies, such as a vacuum vapor deposition, should be used in order to form a uniform reflective layer and protective layer on a surface of the reflective mirror. Therefore, the rear projection type reflective mirror is widely used, which is capable of easily forming the reflective layer and the protective layer.

As shown in FIG. 1, the rear projection type reflective mirror 10 comprises a reflective layer 13 and a protective layer 15 formed on the glass substrate 11. A coating layer 17, such as a paint layer coating, is provided on an upper surface of the protective layer 15 to prevent the reflective layer 13 and the protective layer 15 from being corroded. The glass substrate 11 generally has a thickness of about 3 mm or more to bear any exterior shock, the reflective layer 13 has a thickness of about 80 nm, and the protective layer 15 has a thickness of about 62 nm. Accordingly, the rear projection type reflective mirror 10 has an overall thickness of about 3 mm.

In the rear projection type reflective mirror 10, the image light must pass through the glass substrate 11 so that it can be reflected by the reflective layer 13. However, since the glass substrate 11 is relatively thick and the refractive indexes of air and glass are different, reflections of the image light occur when the image light is incident to the glass substrate 11 from the air, and when the image light exits from the glass substrate 11 to the air. Accordingly, the incident image light generates a real image (I) formed due to the reflection by the reflective layer 13, a first ghost image (II) formed due to a first reflection on the surface of the glass substrate 11, and a second ghost image (III) formed in the following manner. When the real image (I) exits from the glass substrate 11 to the air, it is reflected by the glass substrate 11 and then again reflected by the reflective layer 13. When the second ghost image (III) exits into the air, it may be again reflected, thereby generating a third ghost image. In this manner, many images are generated for one image light due to the repeated reflections.

Accordingly, since a line width of the image to be projected through the screen becomes thicker, a double image is formed due to the overlapped images, or a focus characteristic and contrast is deteriorated, thereby causing the entire image quality to be deteriorated.

Degrees of the phenomena are different according to positions of the screen. As shown in FIG. 2B, the image light is reflected by the reflective mirror 10 and is then incident to the screen 20. At this time, an incident angle of the image light becomes larger from a lower part of the reflective mirror 10 toward an upper part thereof. As the incident angle becomes larger, distances between the real image (I) and the first and second ghost images (II and III) become farther.

FIG. 2A illustrates resolutions in upper, center, and lower areas of the screen 20. In the graph of FIG. 2A, portions shown with square waves indicate positions of each of a plurality of scanning lines. As shown, the image light incident to the lower area of the screen 20 has a narrow distance between a brightness component (α) indicating the real image, and a brightness component (α′) indicating the first and second ghost images (II and III). In contrast, the image light incident to the upper area of the screen 20 has a wide distance between a brightness component (β) indicating the real image, and a brightness component (β′) indicating the first and second ghost images, such that it overlaps an area of other scanning lines. Accordingly, the line width is thicker toward the upper area of the screen 20, such that the image quality is deteriorated.

In order to solve the above problems, a Japanese patent publication No. H5-224295 entitled “A Reflector For A Screen Projection Type Monitor”, the entire disclosure of which is incorporated herein by reference, discloses a reflective mirror 10 that is formed with two layers, including a glass layer and a fiber reinforced plastic layer, and a core material such as foaming agent interposed between the glass layer and the fiber reinforced plastic layer. In addition, a reflective film made of vapor deposited aluminum is formed on a surface of the glass layer facing the core material. Thereby, since a thickness of the glass layer can be reduced to 2 mm, the image quality can be improved as compared to the reflective mirror 10 having a thickness of 3 mm. However, the improvement effect is negligible because a degree of thickness reduction is too low. Also, when the glass layer is made to be thinner, it may be damaged even by a small exterior shock. Accordingly, it is troublesome to make the glass layer thinner since a sufficient strength cannot then be guaranteed. In addition, according to the conventional devices, since the reflective mirror 10 is formed with several layers adhered to each other, the manufacturing process is complicated and costs are increased.

Therefore, a need exists for a method and apparatus that is capable of drastically reducing the thickness of the glass substrate 11 while maintaining a sufficient strength of the reflective mirror 10 in order to minimize the double image and to improve the focus characteristics and contrast, thereby improving the image quality. In addition, a need exists for a method and apparatus that is capable of simplifying the manufacturing process of the reflective mirror 10 and reducing costs.

### SUMMARY OF THE INVENTION

Accordingly, it is an object of the present invention to provide a projection TV that is capable of reducing a thickness of a reflective mirror to the greatest extent, thereby improving an image quality.

Another object of the present invention is to provide a projection TV that is capable of simplifying a manufacturing process thereof and reducing costs.

The above and other objects of the present invention are substantially realized by providing a projection TV comprising a reflective mirror including an ultra-thin glass substrate having enhanced strength, a reflective layer formed on a surface of the glass substrate to reflect an image, and a protective layer applied to an upper surface of the reflective layer to prevent the reflective layer from being damaged.

Preferably, the glass substrate may be made of tempered glass having a heat-enhanced strength which is formed by heat-treating at a softening temperature or greater, and then cooling with compressed cooling air.

Preferably, a thickness of the reflective mirror may be between about 0.7 and about 1.8 mm.

### BRIEF DESCRIPTION OF THE DRAWINGS

The above aspects and features of the present invention will become more apparent by describing certain embodiments of the present invention with reference to the accompanying drawings, in which:

FIG. 1 is a sectional view of a conventional reflective mirror for a projection TV;

FIG. 2A is a graph showing the brightness of a screen of a projection TV having a conventional reflective mirror;

FIG. 2B is a schematic view showing projection paths of image light in a conventional projection TV;

FIG. 3 is a sectional view of a reflective mirror for a projection TV according to an embodiment of the present invention; and

FIG. 4 is a graph showing the brightness of a screen of a projection TV having a reflective mirror according to an embodiment of the present invention.

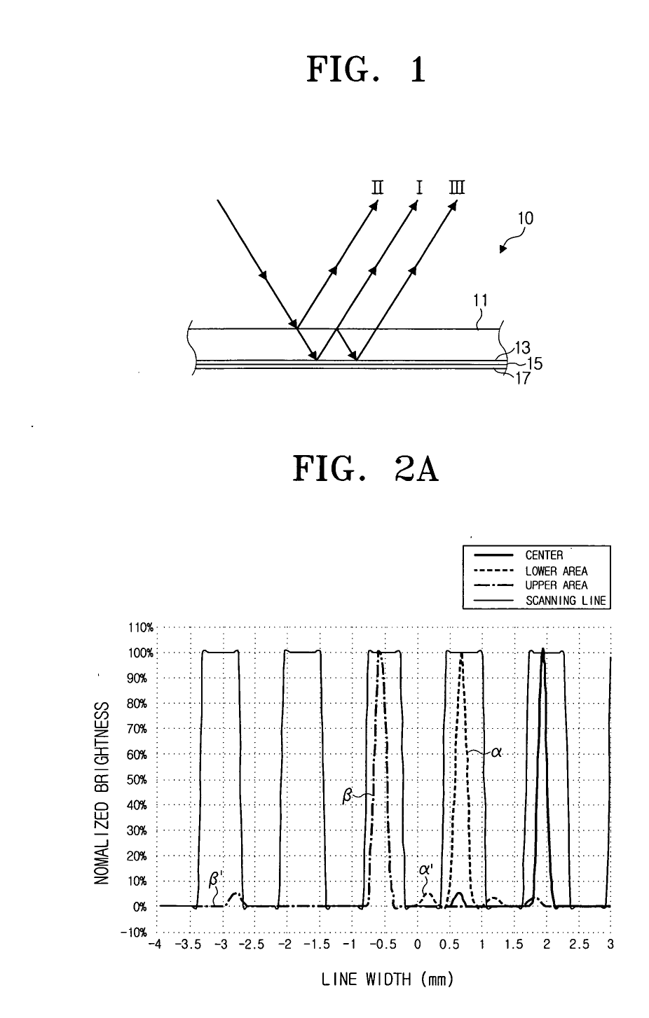

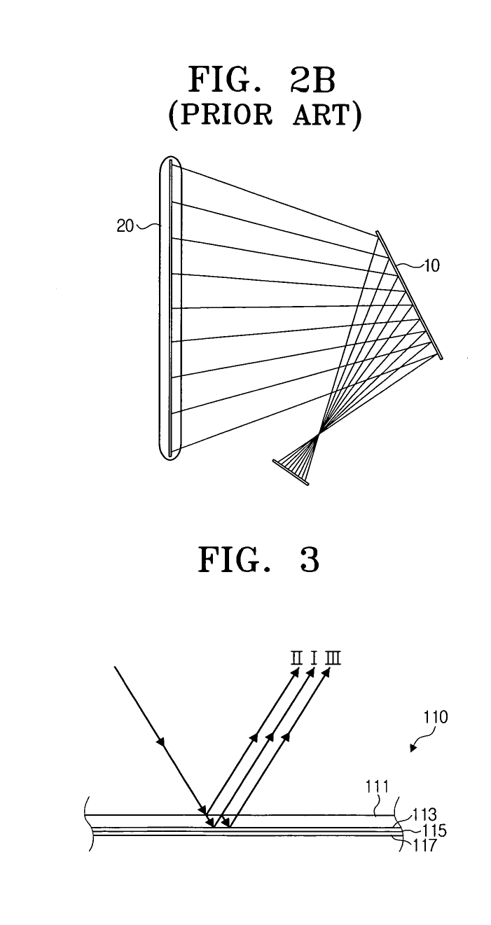

Throughout the drawings, like reference numerals will be understood to refer to like parts, components and structures.

### DETAILED DESCRIPTION OF THE EXEMPLARY EMBODIMENTS

Hereinafter, a number of exemplary embodiments of the present invention will be described with reference to the accompanying drawings. In the following description, detailed descriptions of known functions and configurations incorporated herein are omitted for clarity and conciseness.

FIG. 3 is a sectional view of a reflective mirror according to an embodiment of the present invention. As shown, the reflective mirror 110 is manufactured by vapor depositing a reflective layer 113 and first and second protective layers 115 and 117, respectively, on a rear surface of an ultra-thin glass substrate 111 having an enhanced strength.

The glass substrate 111 of the reflective mirror 110 is comprised of tempered glass having a heat-enhanced strength. Typically, tempered glass is formed by heating a formed plate glass to 500˜700° C., close to a softening temperature, and then quenching the heated glass with compressed cooling air. By doing so, a surface of the glass is compressive-strained and an interior thereof is tensile-strained, so that strength is enhanced. The tempered glass has a bending strength of 3˜5 times higher than that of conventional glass, a shock resistance of 3˜8 times higher than that of the conventional glass, and an excellent heat resistance. Accordingly, the tempered glass can be made to be remarkably thin as compared to the conventional glass, even when it has the same strength as the conventional glass.

The glass substrate 111 of the reflective mirror 110, which is made of the tempered glass, has a thickness of about 0.7˜1.8 mm, and preferably about 1˜1.5 mm. That is, the resulting reflective mirror 110 has a thickness which is about ½˜⅓ that of the conventional reflective mirror 10, and which is about ½˜¾ that of the mirror disclosed in the Japanese patent publication No. H5-224295, referenced above. Accordingly, it is possible to manufacture the ultra-thin reflective mirror 110 having a same or greater enhanced strength.

The glass substrate 111 should also have a sufficiently flat rear surface on which the reflective layer 113, and the protective layers 115 and 117 are formed. Therefore, the glass substrate is preferably selected from plate glass which is substantially flat and has substantially no flaws for forming the tempered glass.

The reflective layer 113 is vapor-deposited on the rear surface of the glass substrate 111, and is comprised of a layer formed by vapor depositing silver (Ag), aluminum (Al), or the like, for reflecting an image light. The reflective layer 113 is typically made to have a thickness of about 90 nm or less.

The first protective layer 115 is formed on an upper surface of the reflective layer 113 by vapor depositing copper (Cu), lead (Pb), silicon dioxide (SiO₂), or the like. The first protective layer 115 is preferably coated with several layers. One or more of the layers of the first protective layer 115 can be formed by selecting one of copper, lead, and silicon dioxide. Alternatively, one or more of copper, lead, and silicon dioxide may be mixed and then coated as the layers of the first protective layer 115. The thickness of the first protective layer is made to be several microns or less. If the first protective layer 115 is formed with several layers, all of the layers of the first protective layer 115 commonly block the metal component forming the reflective layer 113 from the air, thereby preventing the reflective layer 113 from being corroded due to oxygen or moisture in the air.

A first layer of the first protective layer 115, which directly contacts the reflective layer 113, serves to prevent corrosion and to enhance a coating force of the reflective layer 113. A second layer of the first protective layer 115 serves to increase a reflectivity of the image light on the reflective layer 113. That is, the combined layers of the first protective layer 115 serve to enhance the reflectivity of the reflective layer 113 and to maintain wear resistance.

The second protective layer 117 is formed by applying paint or a similar substance for preventing corrosion to an upper surface of the first protective layer 115, and blocks the reflective layer 113 and the first protective layer 115 from being exposed to the air, thereby preventing corrosion.

When using the reflective mirror 110 having the above structure, the overall thickness of the reflective mirror 110 is about 0.7˜1.8 mm, and preferably 1˜1.5 mm. Accordingly, for a real image (I) formed by the image light reflected on the reflective layer 113, a distance between a first ghost image (II) (which is formed due to a first reflection on the surface of the glass substrate 111), and a second ghost image (III) (which is formed when the real image (I) is emitted from the glass substrate 111 to the air, reflected by the glass substrate 111, and then again reflected by the reflective layer 113), is narrowed to about ⅓ that of the conventional reflective mirror 10.

Accordingly, the image light may generate each of the real image (I), first ghost image (II), and second ghost image (III), or may generate only the real image (I), according to the incident angles to the reflective mirror 110, that is, positions on the screen.

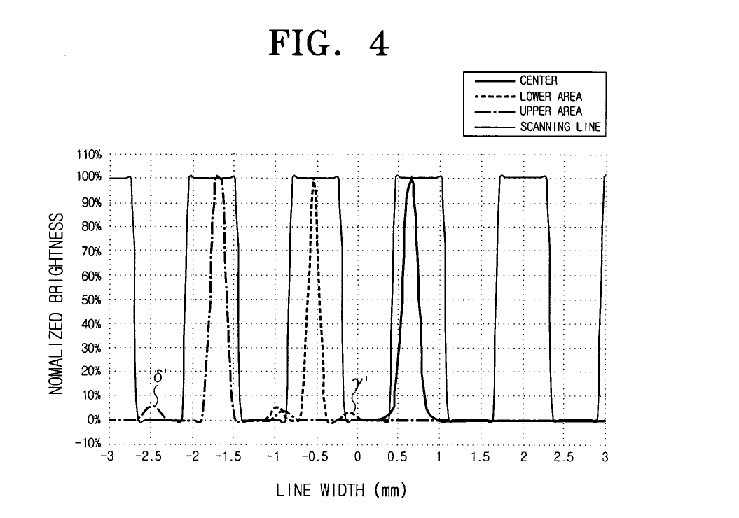

FIG. 4 is a graph showing the brightness of a screen of a projection TV having a reflective mirror 110 according to an embodiment of the present invention. Referring to FIG. 4, the image light passing through a center area of the screen does not show brightness components for the first and second ghost images (II and III). Accordingly, it is possible to view a clear image in the center area of the screen, as commonly experienced with the front projection type reflective mirror.

In the case where the image light passes through a lower area of the screen, only parts of the brightness components (γ′) for the first and second ghost images (II and III) are formed in positions which are slightly deviated from the scanning lines. Accordingly, the screen resolution of the lower area is more enhanced than the resolution formed in the lower area when the conventional reflective mirror 10 is used. In the case of the image light reaching an upper area of the screen, the brightness components (δ′) for the first and second ghost images (II and III) are formed between neighboring scanning lines. Accordingly, although the line width of the image light is slightly increased, the image light no longer overlaps the other scanning lines.

The reflective mirror 110 of the embodiments of the present invention uses tempered glass to reduce the thickness of the glass substrate 111 to about ⅓ that of the conventional reflective mirror 10, such that the line width of the image light passing through the screen is reduced to about ⅓ that of the conventional reflective mirror. Accordingly, embodiments of the present invention minimize the occurrences of a double image, and a focus characteristic and contrast are enhanced, thereby improving the image quality. As a result, it is possible to obtain image clarity that is substantially identical to that provided by the use of the front projection type reflective mirror. Further, it is possible to manufacture the reflective mirror at a low cost as compared to the front projection type reflective mirror, while achieving substantially similar effects as the front projection type reflective mirror.

In addition, a lightweight product can be made since the total weight of the projection TV is decreased due to the thinning of the reflective mirror 110.

Further, since the glass substrate 111 is manufactured by heat strengthening a single glass plate, the reflective mirror 110 has an enhanced strength. Accordingly, it is possible to prevent damage to the product due to delivery or carelessness, and further prevent human injuries due to such damage. Additionally, unlike the conventional methods of manufacturing the reflective mirror using glass and reinforced plastics, an ultra-thin tempered glass is used, such that the manufacturing process is shortened and costs are reduced. Accordingly, competitive goods can be obtained.

The foregoing embodiments and advantages are merely exemplary, and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A reflective mirror for a projection TV or similar device, comprising:
an ultra-thin glass substrate having enhanced strength;
a reflective layer formed on a surface of the glass substrate to reflect an image; and
a protective layer applied to an upper surface of the reflective layer to prevent the reflective layer from being damaged.

2. The reflective mirror for a projection TV or similar device as claimed in claim 1, wherein the glass substrate comprises a tempered glass having a heat-enhanced strength.

3. The reflective mirror for a projection TV or similar device as claimed in claim 2, wherein the glass substrate is formed by heat-treating a glass plate at a softening temperature or greater, and then cooling with compressed cooling air.

4. The reflective mirror for a projection TV or similar device as claimed in claim 1, wherein a thickness of the glass substrate is between about 0.7 mm and about 1.8 mm.

5. The reflective mirror for a projection TV or similar device as claimed in claim 1, wherein a thickness of the glass substrate is between about 1 mm and about 1.5 mm.

6. The reflective mirror for a projection TV or similar device as claimed in claim 1, wherein the reflective layer is vapor-deposited on a rear surface of the glass substrate, and is comprised of at least one of a silver (Ag) and aluminum (Al) material.

7. The reflective mirror for a projection TV or similar device as claimed in claim 1, wherein a thickness of the reflective layer is about 90 nm or less.

8. The reflective mirror for a projection TV or similar device as claimed in claim 1, wherein the protective layer is vapor-deposited on an upper surface of the reflective layer, and is comprised of at least one of a copper (Cu), lead (Pb), and silicon dioxide (SiO₂) material.

9. The reflective mirror for a projection TV or similar device as claimed in claim 1, wherein a thickness of the protective layer is several microns or less.

10. The reflective mirror for a projection TV or similar device as claimed in claim 8, wherein the protective layer comprises a plurality of layers.

11. The reflective mirror for a projection TV or similar device as claimed in claim 10, wherein the plurality of layers comprise:
a first layer, which directly contacts the reflective layer and is configured to prevent corrosion and to enhance a coating force of the reflective layer; and
a second layer, which is configured to increase a reflectivity of the reflective layer.

12. The reflective mirror for a projection TV or similar device as claimed in claim 11, wherein the second layer comprises a paint layer for preventing corrosion to an upper surface of the first layer.

13. A method for reducing the thickness of a reflective mirror for use in a projection TV or similar device, comprising the steps of:
providing an ultra-thin glass substrate having enhanced strength;
forming a reflective layer on a surface of the glass substrate to reflect an image; and
forming a protective layer on an upper surface of the reflective layer to prevent the reflective layer from being damaged.

14. The method for reducing the thickness of a reflective mirror as claimed in claim 13, wherein the step of providing an ultra-thin glass substrate comprises the steps of:
heat-treating a glass plate at a softening temperature or greater; and
cooling the glass plate with compressed cooling air, wherein the glass substrate has a thickness of between about 0.7 mm and about 1.8 mm.

15. The method for reducing the thickness of a reflective mirror as claimed in claim 13, wherein the step of forming a reflective layer comprises the step of:
vapor-depositing at least one of a silver (Ag) and aluminum (Al) material on a rear surface of the glass substrate to a thickness of about 90 nm or less.

16. The method for reducing the thickness of a reflective mirror as claimed in claim 13, wherein the step of forming a protective layer comprises the step of:
vapor-depositing at least one of a copper (Cu), lead (Pb), and silicon dioxide (SiO₂) material on an upper surface of the reflective layer to a thickness of several microns or less.
